(19) United States
(12) Patent Application Publication
(10) Pub. No.: US 2016/0297927 A1
(43) Pub. Date: Oct. 13, 2016

(54) METHOD FOR PRODUCING POLYMER

(71) Applicants: Satoshi IZUMI, Tokyo (JP); Taichi NEMOTO, Tokyo (JP); Yoko ARAI, Tokyo (JP); Takayuki SHIMIZU, Tokyo (JP); Shigehiro HIRANO, Tokyo (JP); Chiaki TANAKA, Tokyo (JP)

(72) Inventors: Satoshi IZUMI, Shizuoka (JP); Taichi NEMOTO, Shizuoka (JP); Yoko ARAI, Shizuoka (JP); Takayuki SHIMIZU, Kanagawa (JP); Shigehiro HIRANO, Kanagawa (JP); Chiaki TANAKA, Shizuoka (JP)

(21) Appl. No.: 15/038,336

(22) PCT Filed: Nov. 18, 2014
(86) PCT No.: PCT/JP2014/080994

§ 371 Date: May 20, 2016

(30) Foreign Application Priority Data
Nov. 21, 2013 (JP) 2013-240812
Mar. 18, 2014 (JP) 2014-054318

(51) Int. Cl. C08G 65/20; C08G 65/18

(52) U.S. Cl. CPC C08G 65/20; C08G 65/18

(57) ABSTRACT

A method for producing a polymer, which contains bringing a polymerizable monomer and a compressive fluid into contact with each other to melt or dissolve the polymerizable monomer, followed by polymerizing the polymerizable monomer in the presence of an electrophile serving as an initiator.

### TECHNICAL FIELD

The present invention relates to a method for producing a polymer through polymerization of a monomer.

### BACKGROUND ART

Living polymerization has characteristics that a generated polymer has a narrow molecular weight distribution, and a polymer in an amount that is an equimolecular to an initiator can be generated, because the living polymerization is a polymerization method using a polymerization initiation reaction and a propagation reaction, and does not involve a transfer reaction, or a termination reaction. In accordance with the living polymerization, moreover, a polymerization propagation terminal is still active at the time when all the amount of a monomer are consumed, and thus polymerization starts again as another type of a monomer is added. As a result, a copolymer can be synthesized.

As for living polymerization industrially performed, there is, for example, a living cationic polymerization of polytetrahydrofuran (PTHF), which is disclosed in PTL 1. PTHF is an intermediate product that is used for various applications in the plastic industry and plastic fiber industry. Particularly, PTHF is used as a diol component for producing a polyurethane elastomer, a polyester elastomer, or a polyamide elastomer, and has been widely utilized in every day living by being processed into an industrial product, such as a roll, or an elastic fiber for shoe soles, or clothes (e.g., Spandex).

PTHF is industrially produced through polymerization of tetrahydrofuran (THF) using a catalyst in the presence of a reagent, such as a telogen (chain transfer agent). In this case, a chain length of a polymer chain and a molecular weight of the polymer can be adjusted by selecting a type and amount of the telogen for use. As one example of a production method of PTHF, known is a method for producing PTHF with one stage (one-step method) by polymerizing THF using an acid catalyst, and water, 1,4-butanediol, or low molecular weight PTHF as a telogen. When PTHF is produced by the one-step method, however, there is a case where a transformation rate of THF into a polymer is low.

As for a method for achieving the higher transforming rate than the one-step method, a two-step method has been known, and the two-step method has been used as a main method for polymerization of a large industrial scale. In this method, a functional group is additionally introduced either or both terminals of a polymer chain by selecting a telogen. Specifically, carboxylic acid or carboxylic acid anhydride is selected as a telogen, and THF is polymerized, for example, in an inhomogeneous system, i.e., in the presence of a catalyst that is not sufficiently dissolved, to thereby first produce monoester or diester of PTHF. Subsequently, PTHF is obtained by saponification, ester-exchange, or hydrolysis of the ester.

In order to appropriately control a reaction with preventing generation of ether peroxide, or to suppress thermal degradation of a product, polymerization reaction temperature may be controlled to low temperature at which the aforementioned control can be achieved, in the case where living cationic polymerization is performed. In this case, a viscosity of a reaction product increases as a polymerization reaction progresses even when the two-step method is used. Therefore contacting ratio between the monomer, the polymerization initiator, and the catalyst becomes low, to thereby widen the average molecular weight distribution of a resulting polymer product, and reduces a transformation rate of the monomer.

In the case where THF is polymerized, for example, a low molecular weight oligomer, such as PTHF-THF copolymer having the average molecular weight of 100 to 500, is generated, which may affect polydispersity, and color number. Moreover, there are problems that impurities, such as sodium ions, or methanol may be contained due to ester exchange, depending on the production conditions. Methanol functions as a telogen, which affects chain termination in polymerization of THF. On the other hand, methanol cannot be separated in depolymerization. Therefore, a reduction in an amount of methanol has been desired.

As for a method for reducing an amount of methanol, PTL 2 discloses a method where a methanol content in PTHF is reduced to less than 2% by distillation, and condensation. The resultant however contains a trace of methanol, and therefore it is difficult to control a molecular weight thereof. Moreover, a distillation step needs to be provided separately from the polymerization step, and the distillation is performed for several hours at relatively high temperature, i.e., about 170° C. Therefore, a production cost increases, and also a large quantity of thermal energy is consumed to thereby increase the environmental load.

In living cationic polymerization, moreover, cyclic ether tends to be generated as a by-product. The cyclic ether is a polymer formed into a ring, and does not have a reactive hydroxyl group at a terminal thereof. In the case where a generated product is used for production of a polyester or polyurethane resin, therefore the cyclic ether becomes impurities in a raw material. In the case where a generated product is used for production of a polyurethane resin, moreover, the cyclic ether acts as an excess plasticizer for a polyurethane resin, which tends to deteriorate characteristics of the polyurethane resin.

As for a method for removing a cyclic oligomer from a polymer product, there is a method for separating or removing the cyclic oligomer after the polymerization. As examples of the method thereof, disclosed are an extraction method where water or hydrocarbon is used as an extraction solvent (see PTL 3), and a method where distillation and extraction are combined (see PTL 4).

In accordance with the method using distillation, however, a removal component is limited to a relatively low molecular weight component, such as up to a dimmer to hexamer of THF, due to the limitation of the vapor pressure, and therefore there is a problem that a chain oligomer that is a main component is removed at the same time. The method using extraction is also only effective for a low molecular weight component that has high selectivity of a cyclic product and a chain product to an extraction solvent for use, and has a problem that a cyclic product also present at the side of a high molecular weight molecule cannot be removed.

### CITATION LIST

### Patent Literature

PTL 1: Japanese Patent Application Laid-Open (JP-A) No. 07-228684

PTL 2: Japanese Translation of PCT International Application (JP-A) No. 2007-506811

PTL 3: Japanese Patent Publication Application (JP-B) No.

PTL 4: JP-A No. 01-92221

### SUMMARY OF INVENTION

### Technical Problem

When a monomer is polymerized through cationic polymerization at the aforementioned low temperature, as described above, there are problems that the polymerization reaction is hardly progressed as a viscosity of a reaction product increases along with the progress of the reaction, and thus a transformation rate is low.

### Solution to Problem

The means for solving the aforementioned problems are as follows:

The method for producing a polymer of the present invention contains:

bringing a polymerizable monomer and a compressive fluid into contact with each other to melt or dissolve the polymerizable monomer, followed by polymerizing the polymerizable monomer in the presence of an electrophile serving as an initiator.

### Advantageous Effects of Invention

The present invention exhibits an effect that a polymerization reaction is progressed smoothly, and a transformation rate is improved, even when a monomer is polymerized through cationic polymerization at low temperature.

### BRIEF DESCRIPTION OF DRAWINGS

FIG. 1 is a general phase diagram depicting a state of a substance depending on temperature and pressure.

FIG. 2 is a phase diagram for defining a range of a compressive fluid.

FIG. 3 is a system diagram illustrating one example of a polymerization step of a continuous system.

FIG. 4 is a system diagram illustrating another example of a polymerization step of a continuous system.

FIG. 5 is a system diagram illustrating one example of a polymerization step of a batch system.

### DESCRIPTION OF EMBODIMENTS

An embodiment of the present invention is specifically explained hereinafter. The method for producing a polymer according to the present embodiment contains bringing a polymerizable monomer and a compressive fluid into contact with each other to melt or dissolve the polymerizable monomer, followed by polymerizing the polymerizable monomer in the presence of an electrophile serving as an initiator. The polymerizable monomer is referred to merely as a monomer, hereinafter.

### <<Raw Materials>>

First, substances, such as a monomer, and a catalyst, which are used as raw materials in the production method, are explained. Note that, in the present embodiment, the term “raw materials” means materials that will be constitutional components of a polymer. The raw materials contain a monomer, and may further contain appropriately selected optional components, such as an initiator, and additives, according to the necessity.

### <Monomer>

The monomer is appropriately selected depending on the intended purpose without any limitation, provided that it is capable of carrying out cationic polymerization (i.e., it is cationic polymerizable). Examples of the monomer include C3-C12 olefine, conjugated diene, cyclic ether, vinyl ether, and an aromatic vinyl compound. Among them, preferred are C3-C12 olefine, conjugated diene, and cyclic ether. Specific examples thereof include isobutylene, propylene, 1-butene, 2-butene, 2-methyl-1-butene, 3-methyl-2-butene, pentene, 4-methyl-1-pentene, hexene, 5-ethylidene norbornene, vinylcyclohexane, butadiene, isoprene, cyclopentadiene, methyl vinyl ether, ethyl vinyl ether, isobutyl vinyl ether, styrene, α-methyl styrene, p-methyl styrene, dimethyl styrene, monochlorostyrene, dichlorostyrene, β-pinene, indene, tetrahydrofuran, oxetane, oxepane, 1,4-dioxan, 2-methyl tetrahydrofuran, 3-methyl tetrahydrofuran, and butylene oxide. Among them, preferred are isobutylene, propylene, 1-butene, 2-butene, styrene, p-methyl styrene, α-methyl styrene, indene, isoprene, cyclopentadiene, and tetrahydrofuran. Among them, a monomer having a cyclic structure is preferable, cyclic ether is more preferable, and tetrahydrofuran is even more preferable.

In the production method of the present embodiment, these monomers may be used alone, or in combination. In the case where tetrahydrofuran is used as a monomer, for example, the monomer may be used in combination with another cationic polymerizable monomer other than tetrahydrofuran. Use of these monomers in combination can produce a copolymer having two or more, polymer segments. As for the polymer product having two or more polymer segments, a block copolymer (block polymer) having a plurality of polymer segments in combination is preferable in view of sufficiently exhibiting an effect obtainable by the production method of the present embodiment.

In the present embodiment, a block polymer is a linear copolymer to which pluralities of homopolymer chains are bonded as blocks. A typical example of the block polymer is a A-B diblock polymer having a structure where an A block chain having a repeating unit A and a B block chain having a repeating unit B are bonded to each other at a terminal thereof, i.e., -(AA . . . AA)-(BB . . . BB)-. A block polymer where 3 or more polymer chains are bonded may be used. In case of a triblock polymer, a structure thereof may be A-B-A, B-A-B, or A-B-C. Moreover, a star block polymer where one or pluralities of block chains are radially extended from the center thereof can be used. A block having 4 or more block chains, such as (A-B)n type, and (A-B-A)n type, may be used.

Moreover, the copolymer having two or more polymer segments include a copolymer having a multibranched structure, such as a graft polymer. The graft polymer has a structure where a block chain serving as a side chain is hanged from another polymer principle chain. In the graft polymer, a plurality type of polymers can be hanged as side chains. Moreover, a combination of a block polymer and a graft polymer where C block chain is hanged from a block polymer, such as A-B block polymer, A-B-A block polymer, and B-A-B block polymer, may be used. The block polymer is preferably used over the graft polymer because a polymer having a narrow molecular weight distribution tends to be attained, and a composition rate thereof can be easily controlled. A block polymer is explained more in the descriptions below, but the descriptions for the block polymer are also applied to the graft polymer.

### <Initiator>

As for the initiator applicable in the production method of the present embodiment, an electrophile typically used as an initiator of living cationic polymerization is suitably used. As a method for efficiently performing an initiation reaction of living cationic polymerization, an inifer method has been developed. The inifer method is a method where a compound, such as a compound containing a chlorine atom bonded to tertiary carbon, and a chlorine compound containing an aromatic ring at the α-site, is used as a polymerization initiator. The inifer method is suitably used in the present embodiment. Note that, the inifer method is disclosed, for example, in U.S. Pat. No. 4,276,394, the descriptions of which are incorporated herein for reference.

The initiator used in the inifer method is not particularly limited as long as it exhibits an effect as an initiator. A typical example thereof is an initiator having the following structure:

(X—CR₁R₂)nR₃

In the formula above, X is a halogen atom; R₁ and R₂ may be identical or different, and are each a C1-C20 monovalent hydrocarbon group; and R₃ is a C1-C20 n-valent hydrocarbon group; and n is an integer of 1 to 4.

Typical examples thereof include (1-chloro-1-methylethyl)benzene, 1,4-bis(1-chloro-1-methylethyl)benzene (referred to as “p-DCC” hereinafter), and 1,3,5-tris(1-chloro-1-methylethyl)benzene (referred to as “TCC” hereinafter). These may be used alone, or in combination. In the present embodiment, such the initiator containing an aromatic ring is preferably used. In the case where a bifunctional polymer is required, moreover, a bifunctional initiator, such as p-DCC, can be selected. Moreover, a monofunctional initiator, a trifunctional initiator, such as TCC, or a multifunctional initiator is selected depending on the necessity.

A telogen (chain transfer agent) can be used as an initiator in the present embodiment. As for the telogen, for example, a mixture containing C2-C12 carboxylic acid anhydride and/or protonic acid, and C2-C12 carboxylic acid anhydride is preferable. In the case where polyether is produced by reacting cyclic ether through a ring-opening polymerization reaction, specifically, the cyclic ether can be polymerized in the presence of carboxylic acid anhydride, or carboxylic acid, or both. The protonic acid is organic acid or inorganic acid, which is soluble in a reaction system. Examples of the C2-C12 carboxylic acid include acetic acid, sulfonic acid, sulfuric acid, hydrochloric acid, and phosphoric acid. Moreover, acetic acid anhydride, or acetic acid, or both may be used as the initiator. These may be used alone, or in combination.

Moreover, a polymer product containing an alcohol residue at a terminal thereof, such as polycaprolactone diol, and polytetramethylene glycol, may be used as the initiator. Use thereof can synthesize a diblock copolymer, or a triblock copolymer. Moreover, a substance containing a hydroxyl group, such as 1,4-butanediol, and water, may be used as the initiator.

An amount of the initiator for use in polymerization may be appropriately adjusted depending on a target molecular weight of a resulting polymer, and the amount thereof is 0.03 mol % to 30 mol %, preferably 0.05 mol % to 20 mol %, and more preferably 0.1 mol % to 10 mol %, relative to a monomer for use. In order to prevent unevenly initiate polymerization, it is preferred that the monomer and the initiator be sufficiently mixed in advance, before the monomer is brought into contact with a catalyst.

### <Catalyst>

The catalyst is appropriately selected depending on the intended purpose, and the catalyst is, for example, an acid catalyst. Examples of the catalyst include a composite metal oxide catalyst, a metal oxide bearing catalyst, a clay catalyst, oxonium salt, protonic acid, and a Lewis acid catalyst.

As for the composite metal oxide catalyst, a catalyst using any of elements of Group 3, Group 4, Group 13, and Group 14 of the periodic table, which is represented by MxOy (where M is a metal, and x and y are each an integer of 1 to 3) is particularly suitably used. Specific examples of the composite metal oxide catalyst include Al₂O₃—SiO₂, SiO₂—TiO₂, SiO₂—ZrO₂, and TiO₂—ZrO₂. Moreover, a catalyst containing an amorphous silicon or aluminum mixture oxide as a base may be used, and specific examples thereof include SnO₂/SiO₂, Ga₂O₃/SiO₂, Fe₂O₃/SiO₂, In₂O₃/SiO₂, Ta₂O₅/SiO₂ and HfO₂/SiO₂. The aforementioned catalyst may be produced by a coprecipitation method or a sol-gel method.

The metal oxide bearing catalyst is a catalyst, in which tungsten oxide or molybdenum oxide is provided, for example, on ZrO₂, TiO₂, HfO₂, Y₂O₃, Fe₂O₃, Al₂O₃, SnO₂, SiO₂, or ZnO. As for the metal oxide bearing catalyst, moreover, preferred is a ZrO₂/SiO₂-catalyst a carrier of which has an alkaline metal concentration of less than 5,000 ppm. The clay catalyst is preferably a bleaching clay, particularly preferably activated montmorillonite, zeolite, and sheet silicate.

Moreover, preferably polymerization catalysts are zirconium oxide treated with sulfuric acid, aluminum oxide treated with sulfuric acid, heteropolyacid born on a carrier, ammonium bifluoride (NH₄FHF) born on a carrier, and antimony pentafluoride born on a carrier.

Examples of the oxonium salt include tetramethyl oxonium tetrafluoroborate, and triethyl oxonium tetrafluorobrate. Examples of the protonic acid include: inorganic acid, such as hydrochloric acid, sulfuric acid, nitric acid, phosphoric acid, fluoboric acid, hydrofluoric acid, and perchloric acid; organic carboxylic acid; phenol; and organic sulfonic acid. Examples of the Lewis acid catalyst include TiCl₄, AlC₁₄, BCl₃, ZnCl₂, SnCl₄, ethyl aluminum chloride, and SnBr₄.

A type and amount of the catalyst for use cannot be determined unconditionally, as they vary depending on a combination of the compressive fluid and monomer for use. The amount of the catalyst is preferably 0.1% by mass to 90% by mass, more preferably 0.5% by mass to 70% by mass, and even more preferably 1% by mass to 60% by mass, relative to a mass of the monomer. When the amount of the catalyst for use is less than 0.1% by mass, the catalyst is deactivated before a polymerization reaction is completed, and therefore a polymer product of an intended molecular weight may not be obtained. When the amount of the catalyst for use is greater than 90% by mass, on the other hand, it may be difficult to control a polymerization reaction.

As for a pretreatment of the catalyst, there is, for example, drying using a gas (e.g., air, and nitrogen) heated to, for example, 80° C. to 200° C., preferably 100° C. to 180° C. In the case where a catalyst that is a solid under the polymerization conditions, a shape of the catalyst is not particularly limited, but a tablet-shape, strand-shape, spherical, ring-shaped, or fragment-shaped catalyst can be used in view of a contacting area. As for the catalyst, tablet, strand, or spherical compacts are preferably used. In case of the spherical catalyst, a diameter thereof is preferably 0.1 mm to 10 mm, preferably 0.3 mm to 5 mm. In case of the tablet, preferred are those having a diameter of 1 mm to 5 mm and height of 1 mm to 3 mm. In case of the strand (extruded product), those having a diameter of 0.5 mm to 4 mm, preferably 1 mm to 3 mm are used. A ratio of the length of the extruded product to the diameter of the extruded product is typically 20:1 to 0.5:1, preferably 5:1 to 1:1. Other than the cylindrical extruded product, for example, a hollow strand, strand with a rib, star-shaped strand, or any other shapes of extruded products known in the art can be used.

### <Other Components>

Other components used in polymerization are appropriately selected depending on the intended purpose without any limitation, and examples thereof include a telogen, and additives.

### (Additives)

The additives are not particularly limited, and examples thereof include a surfactant, a stabilizer, and an antioxidant. As for the surfactant, a surfactant, which melts with the compressive fluid, and has affinity to both the compressive fluid and the monomer, is suitably used. Use of such a surfactant can expect effects that a polymerization reaction can be carried out uniformly, a generated product having a narrow molecular weight distribution is obtained, and a polymer product in the shape of particles is easily obtained.

In the case where the surfactant is used, the surfactant may be added to the compressive fluid, or may be added to the monomer. In the case where carbon dioxide is used as the compressive fluid, for example, a surfactant, in a molecule of which a group having affinity to carbon dioxide and a group having affinity to the monomer are contained, is used. Examples of such the surfactant include a fluorosurfactant, and a silicone surfactant. As for the stabilizer, epoxidized soybean-oil, or carbodiimide is used. As for the antioxidant, 2,6-di-t-butyl-4-methylphenol, or butylhydroxyanisole is used. As for the anticlouding agent, glycerin fatty acid ester, or monostearyl citrate is used. As for the fillers, clay, talc, or silica each having a function as an UV-ray absorber, a heat stabilizer, a flame retardant, an internal releasing agent, or crystal nucleating additives is used. As for the pigment, titanium oxide, carbon black, or ultramarine blue is used.

### <<Compressive Fluid>>

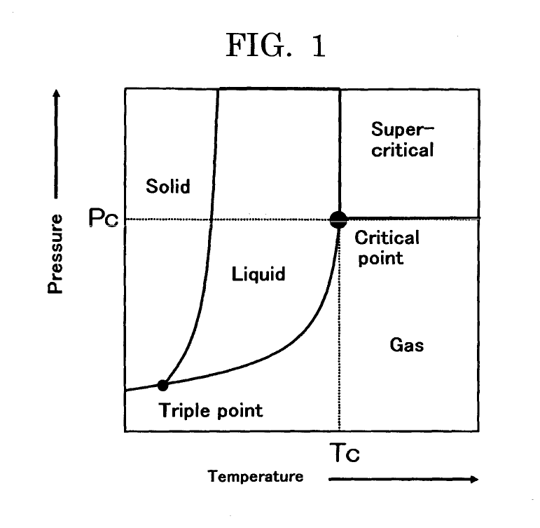

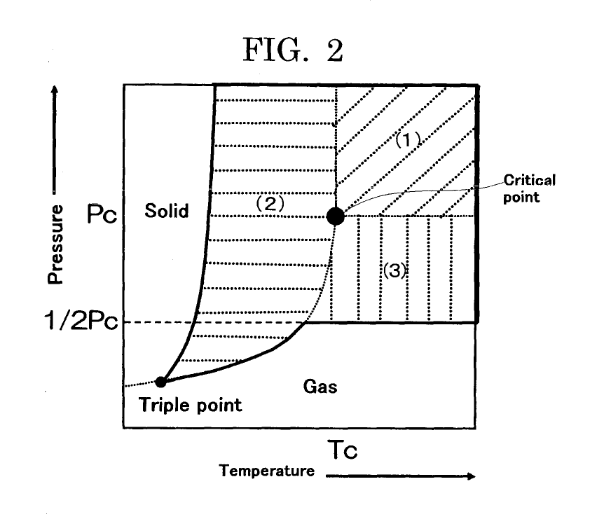

Next, a compressive fluid for use in the production method of the present embodiment is explained with reference to FIGS. 1 and 2. FIG. 1 is a phase diagram illustrating a state of a substance depending on temperature and pressure. FIG. 2 is a phase diagram for defining the range of the compressive fluid in the present embodiment. In the present embodiment, the term “compressive fluid” refers to a state of a substance present in any of the regions (1), (2), or (3) of FIG. 2 in the phrase diagram of FIG. 1.

In such regions, the substance is known to have extremely high density and show different behaviors from those shown at normal temperature and normal pressure. Note that, a substance is a supercritical fluid when it is in the region (1). The supercritical fluid is a fluid that exists as a noncondensable high-density fluid at temperature and pressure exceeding the corresponding critical points, which are limiting points at which a gas and a liquid can coexist. When a substance is in the region (2), the substance is a liquid, but in the present embodiment, it is a liquefied gas obtained by compressing a substance existing as a gas at normal temperature (25° C.) and ambient pressure (1 atm). When a substance is in the region (3), the substance is in the state of a gas, but in the present invention, it is a high-pressure gas whose pressure is ½ or higher than the critical pressure (Pc), i.e. ½ Pc or higher.

Examples of the substance constituting the compressive fluid include carbon monoxide, carbon dioxide, dinitrogen oxide, nitrogen, methane, ethane, propane, 2,3-dimethylbutane, and ethylene, dimethyl ether. Among them, carbon dioxide is preferable, because the critical pressure and critical temperature of carbon dioxide are respectively about 7.4 MPa, and about 31° C., and thus a supercritical state of carbon dioxide is easily formed. In addition, carbon dioxide is non-flammable, and therefore it is easily handled. These compressive fluids may be used alone, or in combination. An amount of the compressive fluid added is appropriately selected depending on the intended purpose without any limitation, but the amount thereof is preferably 0.001% by mass to 80% by mass under the polymerization conditions, more preferably 0.01% by mass or greater but equal to or less than the amount that is the saturation solubility of the compressive fluid to the polymerizable monomer under the polymerization conditions. Note that, the amount is a ratio (% by mass) of the amount of the compressive fluid to a total amount of the raw materials, other additives, and the compressive fluid. Moreover, the polymerization conditions (conditions of the polymerization) are temperature and pressure conditions at the time of the polymerization.

The saturation solubility changes depending on each material, and temperature and pressure conditions. When the amount of the compressive fluid added is greater than the saturation solubility thereof relative to the monomer, however, the compressive fluid cannot dissolve the monomer completely. As a result, the reaction system forms a two-phase state. If polymerization is performed with the amount of the compressive fluid that is greater than the saturation solubility thereof to the monomer under the polymerization conditions, therefore, there are problems that a molecular weight distribution of a resulting polymer product becomes wide due to a short-pass, a transformation rate of the monomer into a polymer becomes low, and polymerization stability is low. In the case where a monomer, such as THF, is polymerized, moreover, it is desirable that polymerization is performed in an inert gas atmosphere in order to avoid formation of ether peroxide in an oxygen atmosphere. In the case where a polymerization reaction is performed under the inert gas-rich conditions with an excessive amount of the compressive fluid, polymerization stability is significantly deteriorated due to the aforementioned reason. Therefore, it is desired that an amount of the compressive fluid added is appropriately selected to suite reacting matter.

According to the present embodiment, a monomer can be melted or dissolved without using an organic solvent by bringing the monomer into contact with a compressive fluid. Note that, in the present embodiment, “melting” denotes a state where raw materials or a generated polymer is plasticized with swelling, or liquidized by being in contact with a compressive fluid. Moreover, “dissolving” denotes a state where raw materials are dissolved in a compressive fluid.

### <<Polymerization Reaction Apparatus>>

Subsequently, a polymerization reaction apparatus for use in the production of a polymer in the present embodiment is explained.

### <Continuous Polymerization Reaction Apparatus>

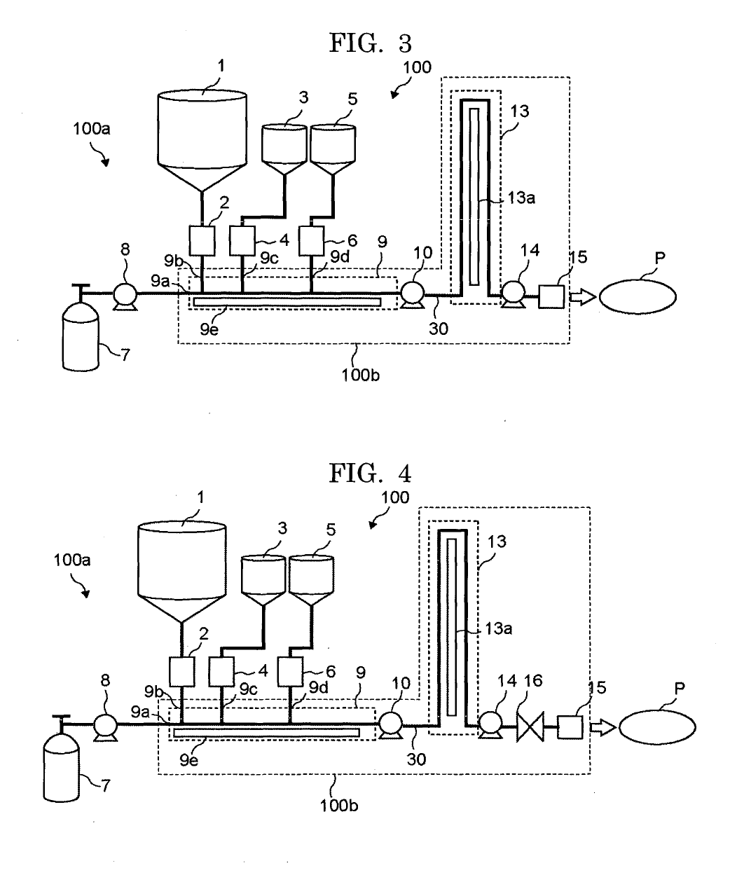

Subsequently, a continuous polymerization reaction is explained with reference to FIGS. 3 and 4. FIGS. 3 and 4 are each a system diagram illustrating one example of the polymerization step. In the system diagram of FIG. 3, the polymerization reaction apparatus 100 contains a supplying unit 100a configured to supply raw materials, such as a monomer, and a compressive fluid, and a polymerization reaction apparatus main body 100b, which is one example of a continuous polymerization apparatus configured to polymerize the monomer supplied by the supplying unit 100a. The supplying unit 100a contains tanks (1, 3, 5, 7), a metering feeder (4), and metering pumps (2, 6, 8). The polymerization reaction apparatus main body 100b contains a contacting unit 9 provided at one end of the polymerization reaction apparatus main body 100b, a feeding pump 10, a reaction unit 13, a metering pump 14, and an extrusion cap 15 provided at the other end of the polymerization reaction apparatus main body 100b.

The tank 1 of the supplying unit 100a is configured to store a monomer. The monomer to be stored may be a powder, or of a melted state. The tank 3 is configured to store solids (a powder or granules) among the initiator and additives. The tank 5 is configured to store liquids among the initiator and the additives. The tank 7 is configured to store the compressive fluid. Note that, the tank 7 may store a gas or a solid, which is turned into a compressive fluid by being heated or compressed during it is supplied to the contacting unit 9, or within the contacting unit 9. In this case, the gas or solid stored in the tank 7 is turned into a state of (1), (2), or (3) of FIG. 2 in the blending device 9 upon application of heat or pressure.

The metering feeder 2 configured to measure the monomer stored in the tank 1 and to continuously supply the monomer to the contacting unit 9. The metering feeder 4 is configured to measure the solid stored in the tank 3 and to continuously supply the solid to the contacting unit 9. The metering pump 6 is configured to measure the liquid stored in the tank 5 and to continuously supply the liquid to the contacting unit 9. The metering pump 8 is configured to continuously supply the compressive fluid stored in the tank 7 to the contacting unit 9 at the constant pressure and the constant flow rate.

Note that, the phrase “continuously supply” used in the present embodiment is a concept with respect to a method for supplying per batch, and means supplying in a manner that a polymer is continuously attained. Specifically, each material may be intermittently supplied as long as a polymer is continuously attained. In the case where the initiator and the additives are all solids, the polymerization reaction apparatus 100 may not contain the tank 5 and the metering pump 6. In the case where the initiator and the additives are all liquids, similarly, the polymerization reaction apparatus 100 may not contain the tank 3 and the metering feeder 4.

In the present embodiment, each device of the polymerization reaction apparatus main body 100b is connected with a pressure resistant pipe 30, through which the raw materials, the compressive fluid, or the generated polymer is passed through, as illustrated in FIG. 3. Moreover, each of the contacting unit 9, feeding pump 10, and reaction unit 13 of the polymerization reaction apparatus has a pipe-shaped member through which the aforementioned raw materials are passed through.

The contacting unit 9 of the polymerization reaction apparatus main body 100b is a device containing a pressure resistant vessel configured to continuously bringing the raw materials, such as the monomer, the initiator, and the additives, each supplied from the tanks (1, 3, 5) into contact with the compressive fluid supplied from the tank 7 to dissolve or melt the raw materials. In the contacting unit 9, the raw materials are dissolved or melted by bringing the raw materials into contact with the compressive fluid. Note that, in the present embodiment, “melting” denotes a state where raw materials or a generated polymer is plasticized with swelling, or liquidized by being in contact with a compressive fluid. Moreover, “dissolving” denotes a state where raw materials are dissolved in a compressive fluid.

In the case where the monomer is dissolved, a fluid phase is formed. In the case where the monomer is melted, a melt phase is formed. It is preferred that one phase of either the melt phase or the fluid phase be formed in the contacting unit 9 in order to carry out a reaction uniformly. In order to carry out the reaction at a high ratio of the raw materials to the compressive fluid, the monomer is preferably melted in the contacting unit 9. Note that, in the present embodiment, the raw materials, such as the monomer, and the compressive fluid can be continuously brought into contact with each other in the contacting unit 9 at the constant ratio of concentration, by continuously supplying the raw materials and the compressive fluid. As a result, the raw materials, such as the monomer, and the initiator, can be efficiently dissolved, or melted.

The contacting unit 9 may be composed of a tank-shaped device, or a tube-shaped device, but it is preferably a tube-shaped device from one end of which the raw materials are introduced, and from the other end of which the mixture, such as a melt phase, and a fluid phase, is taken out. Moreover, the contacting unit 9 may be equipped with a stirring device configured to stir the raw materials, and the compressive fluid. In the case where the contacting unit 9 contains the stirring device, preferably used as the stirring device is a single screw stirring device, a twin-screw stirring device where screws are engaged with each other, a biaxial mixer containing a plurality of stirring elements which are engaged or overlapped with each other, a kneader containing spiral stirring elements which are engaged with each other, or a static mixer. Particularly, the twin-screw or multi-screw stirring device where screws are engaged with each other is preferable, as there is less depositions of a reaction product to the stirring device or the vessel, and they have a self-cleaning function.

The contacting unit 9 is provided with an inlet 9a, which is one example of a compressive fluid inlet configured to introduce the compressive fluid supplied from the tank 7 by the metering pump 8, an inlet 9b, which is one example of a monomer inlet configured to introduce the monomer supplied from the tank 1 by the metering pump 2, an inlet 9c from which a powder supplied from the tank 3 by the metering feeder 4 is introduced, and an inlet 9d from which a liquid supplied from the tank 5 by the metering pump 6 is introduced. In the present embodiment, each inlet (9a, 9b, 9c, 9d) is composed of a pipe member, such as a cylinder or part of the pipe 30 for supplying the raw materials in the contacting unit 9, and a connector configured to connect pipes for transporting each raw material or the compressive fluid. The connector is not particularly limited, and a conventional connector, such as a reducer, a coupling, a Y-type connector, a T-type connector, and an outlet, is used as the connector. Moreover, the contacting unit 9 is equipped with a heater 9e for heating the supplied raw materials and compressive fluid.

The feeding pump 10 is configured to send the mixture, such as the melt phase and the fluid phase, which has been formed in the contacting unit 9, to the reaction unit 13.

The reaction unit 13 is composed of a pressure resistant device or tube, which is configured to bring the melted raw materials fed by the feeding pump 10 into contact with the catalyst, which is loaded in the reaction unit 13 in advance, to thereby polymerize the monomer. The reaction unit 13 may be composed of a tank-shaped device, or a tube-shaped device, but it is preferably the tube-shaped device, as the tube-shaped device gives less dead-space. Moreover, the reaction unit 13 may contain a stirring device for stirring the raw materials, and the compressive fluid. As for the stirring device of the reaction unit 13, preferred is a dual- or multi-axial stirrer having screws engaging with each other, stirring elements of 2-flights (rectangle), stirring elements of 3-flights (triangle), or circular or multi-leaf shape (clover shape) stirring wings, in view of self-cleaning. In the case where the raw materials including the catalyst are sufficiently mixed in advance, a motionless mixer, which performs division and compounding (recombining) of the flows in multiple stages by a guiding device, can also be used as the stirring device. Examples of the motionless mixer include multiflux batch mixers disclosed in Japanese examined patent application publication (JP-B) Nos. 47-15526, 47-15527, 47-15528, and 47-15533; a Kenics-type mixer disclosed in Japanese Patent Application Laid-Open (JP-A) No. 47-33166; and motionless mixers similar to those listed. In the case where the reaction unit 13 does not have a stirring device, the reaction unit 13 is composed of part of the pressure resistant pipe 30. In this case, a shape of the pipe is not particularly limited, but a spiral pipe is preferable, as a size of the device can be kept small.

In the case where a solid catalyst, which is a solid, is used as the catalyst, moreover; the reaction unit 13 may be provided with a filter for preventing a contamination with the solid catalyst. A pore diameter of the filter can be appropriately selected depending on the size of the solid catalyst, but the diameter thereof is preferably greater than 0.1 μm. In the case where the filter having a pore diameter of 0.1 μm or smaller, pressure loss is caused when the material having a high viscosity is passed through, which may break the device. Moreover, a material of the filter can be appropriately selected depending on temperature and pressure for use, but the material thereof is preferably stainless steel, brass, carbon steel, a metal, an oxide, or an alloy. Particularly, SUS316 stainless steel is preferable in view of thermal resistance, pressure resistance, and anticorrosion.

Note that, the reaction unit 13 may be provided with a gas outlet, from which evaporated products are removed. Moreover, the reaction unit 13 contains a heater 13a for heating the fed raw materials. FIG. 3 illustrates an example where one reaction unit 13 is provided, but the polymerization reaction apparatus may contain two or more reaction units 13. In the case where a plurality of the reaction units 13 are provided, the reaction (polymerization) conditions per reaction unit 13, such as temperature, catalyst concentration, pressure, average retention time, and stirring speed, may be identical, but it is preferred that optimal conditions for reaction unit be selected depending on the progress of the polymerization. Note that, it is not desirable to connect a large number of the reaction units 13 to give many stages, as it may extend a reaction time, or a device may become complicated. The number of the stages is preferably 1 to 4, more preferably 1 to 3.

In the case where polymerization is performed by means of the apparatus containing only one reaction unit, it is typically believed that such an apparatus is not suitable for industrial production, as a degree of polymerization of a polymer to be attained, or an amount of monomer residues in the polymer is unstable and tends to be varied. It is considered that the instability thereof is caused by coexistence of the raw materials having the melt viscosity of a few poises to several tends poises, and the polymer product having the melt viscosity of about 1,000 poises. In the present embodiment, on the other hand, it is possible to reduce a difference in the viscosity within the reaction unit 13 (also referred to as a polymerization system) by melting (liquidizing) the raw materials, and the generated polymer product. Therefore, a polymer product can be stably produced with the polymerization reaction apparatus of the present embodiment, even when a number of stages can be reduced compared to those of a conventional polymerization reaction apparatus.

The metering pump 14 is configured to discharge the polymer product P polymerized in the reaction unit 13 to outside the reaction unit 13 through an extrusion cap 15. Note that, the polymer product P can be also discharged from the reaction unit 13 without using the metering pump 14 by utilizing the pressure difference between inside and outside the reaction unit 13. In this case, a pressure control valve 16 may be used instead of, or in combination with the metering pump 14, as illustrated in FIG. 4, in order to control the pressure inside the reaction unit 13, or the discharging amount of the polymer product P.

### <Batch Polymerization Reaction Apparatus>

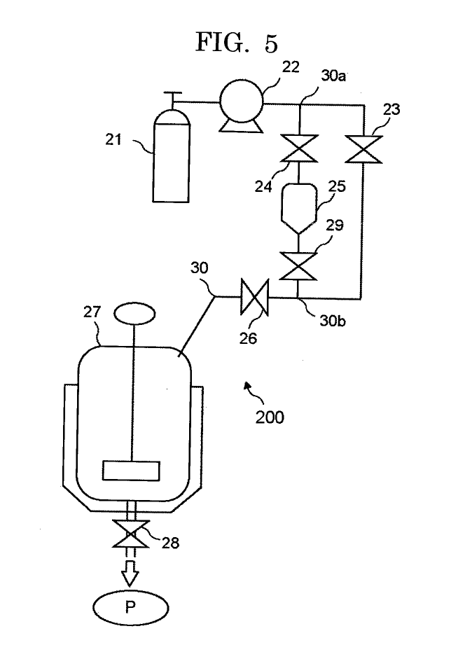

Subsequently, the polymerization reaction apparatus 200 is explained with reference to FIG. 5. FIG. 5 is a system diagram illustrating one example of the polymerization step. In the system diagram of FIG. 5, the polymerization reaction apparatus 200 contains a tank 21, a metering pump 22, an addition pot 25, a reaction vessel 27, and valves (23, 24, 26, 28, 29). Each of the aforementioned devices is connected with a pressure resistant pipe 30 as illustrated in FIG. 4. Moreover, connectors (30a, 30b) are provided to the pipe 30.

The tank 21 is configured to store a compressive fluid. Note that, the tank 21 may store a gas or a solid, which is turned into a compressive fluid by being heated or compressed in a supply channel to the reaction vessel 27, or within the reaction vessel 27. In this case, the gas or solid stored in the tank 21 is turned into a state of (1), (2), or (3) of FIG. 2 in the reaction vessel 27 upon application of heat or pressure.

The metering pump 22 is configured to supply the compressive fluid stored in the tank 21 to the reaction vessel 27 at constant pressure and a constant flow rate. The addition pot 25 is configured to store a catalyst to be added to raw materials in the reaction vessel 27. The valves (23, 24, 26, 29) are configured to switch between a path for supplying the compressive fluid stored in the tank 21 to the reaction vessel 27 via the addition pot 25, and a path for supplying the compressive fluid to the reaction vessel 27 without going through the addition pot 25, by opening and closing.

The reaction vessel 27 is configured to store a monomer and an initiator in advance to initiate polymerization. The reaction vessel 27 is a pressure resistant vessel for polymerizing the monomer by bringing the monomer and initiator stored in advance into contact with the compressive fluid supplied from the tank 21 and the catalyst supplied from the addition pot 25. Note that, the reaction vessel 27 may be provided with a gas outlet for removing evaporated products. Moreover, the reaction vessel 27 is equipped with a heater configured to heat the raw materials and the compressive fluid. Furthermore, the reaction vessel 27 is equipped with a stirring device configured to stir the raw materials and the compressive fluid. Since a settlement of a generated polymer is prevented by stirring with the stirring device, when there is a difference in the density between the raw materials and the generated polymer, a polymerization reaction can be carried out more uniformly and quantitatively. The polymer product P in the reaction vessel 27 is discharged by opening the valve 28 after completing the polymerization reaction. A filter may be provided at the upstream or downstream from the valve 28 in order to prevent contamination of a solid catalyst, when the solid catalyst is used in the reaction system.

### <<Polymerization Method>>

Subsequently, a polymerization method using the polymerization reaction apparatus 100 is explained. In the present embodiment, a monomer and a compressive fluid are continuously supplied, and brought into contact with each other to polymerize the monomer, to thereby continuously obtain a polymer product. First, the metering feeder 4, and the metering pumps (2, 6, 8) are operated to continuously supply a monomer, additives, and a compressive fluid stored in the respective tanks (1, 3, 5, 7). As a result, the raw materials and the compressive fluid are continuously supplied into the tube of the contacting unit 9 from the respective inlets (9a, 9b, 9c, 9d). Note that, the solid (a powder or granules) raw materials may be low in measuring accuracy compared to the liquid raw materials. In this case, the solid raw materials are melted in advance, and stored in the tank 5 as a liquid, and then, the liquidized raw materials may be introduced into the tube of the contacting unit 9 by the metering pump 6. The order for operating the metering feeders (2, 4), metering pump 6, and metering pump 8 is not particularly limited, but it is preferred that the metering pump 8 be operated first, as the raw materials may be solidified due to reduction in temperature, if initial raw materials are sent to the reaction unit 13 without being in contact with the compressive fluid.

The feeding speed of each raw material by each of the metering feeder 4 and the metering pumps (2, 6) is adjusted to be constant based on the predetermined quantity ratio of the monomer, the initiator, and additives. A total mass of the raw materials supplied per unit time by the respective metering feeder 4 and metering pump 6 (the feeding speed of the raw materials (g/min)) is adjusted based on the desired physical properties of a polymer, or a reaction time. Similarly, a mass of the compressive fluid supplied per unit time by the metering pump 8 (the feeding speed of the compressive fluid (g/min)) is adjusted based on the desired physical properties of a polymer, or a reaction time. A ratio of the feeding speed of the raw materials to the feeding speed of the compressive fluid (the feeding speed of the raw materials/the feeding speed of the compressive fluid, which is referred to as a feeding ratio) is appropriately selected depending on the intended purpose without any limitation, but the feeding ratio is preferably 0.01 to 1,000, more preferably 0.1 to 100. When the feeding ratio is less than 0.01, the productivity may be low, as a concentration of the polymer product is extremely low. When the feeding ratio is greater than 1,000, moreover, it is afraid that an ability of the compressive fluid to melt the monomer may be insufficient, and therefore an intended reaction may not be carried out uniformly.

The raw materials and the compressive fluid are continuously introduced into the tube of the contacting unit 9, and therefore the raw materials and the compressive fluid are continuously brought into contact with each other. As a result, the raw materials, such as the monomer, the initiator, and the additives, are blended in the contacting unit 9. In the case where the contacting unit 9 is equipped with a stirring device, the raw materials and the compressive fluid may be stirred. In order to prevent the introduced compressive fluid from turning into a gas, the temperature and pressure inside the tube of the reaction unit 13 are controlled to the temperature and pressure equal to or grater than the triplet point of the compressive fluid. This control is performed by adjusting the output of the heater 9e of the contacting unit 9, or the feeding speed of the compressive fluid. In the present embodiment, the temperature for melting the monomer may be the temperature equal to or lower than the melting point of the monomer at atmospheric pressure. This is because the internal pressure of the contacting unit 9 becomes high in the presence of the compressive fluid, and therefore the melting point of the monomer is lowered than the melting point thereof at atmospheric pressure. Therefore, the monomer is melted in the contacting unit 9, even when an amount of the compressive fluid is small relative to the monomer.

In order to efficiently blend the raw materials, the timing for applying heat or stirring the raw materials and the compressive fluid in the contacting unit 9 may be adjusted. In this case, heating or stirring may be performed after bringing the raw materials and the compressive fluid into contact with each other, or heating or stirring may be performed while bringing the raw materials and the compressive fluid into contact with each other. To make blending of the raw materials even more certain, for example, the monomer and the compressive fluid may be brought into contact with each other after heating the monomer to the temperature equal to or higher than the melting point thereof. In the case where the contacting unit 9 is composed of a biaxial blending device, for example, each of the aforementioned aspects may be realized by appropriately setting an alignment of screws, arrangement of inlets (9a, 9b, 9c, 9d), and temperature of the heater 9e.

In the present embodiment, the additives are supplied to the contacting unit 9 separately from the monomer, but the additives may be supplied together with the monomer. Moreover, the additives may be supplied after the completion of the polymerization reaction. In this case, the additives may be added to the polymer product with kneading, after taking the obtained polymer product out from the reaction unit 13.

The raw materials blended in the contacting unit 9 are sent and supplied to the reaction unit 13 by the feeding pump 10. Meanwhile, the reaction unit 13 is charged with a solid catalyst in advance. As the catalyst functions even at room temperature, in the present embodiment, the catalyst is brought into contact with the raw materials after blending the raw materials and the compressive fluid. In the conventional art, the timing for bringing into contact with the catalyst has not been discussed in a method for polymerizing a monomer using a compressive fluid. In the present embodiment, in the course of the polymerization, the catalyst is brought into contact with the raw materials in the state where the monomer and the initiator are sufficiently dissolved or melted with the compressive fluid in the reaction unit 13 because of the high activity of the catalyst. If the monomer or the initiator is brought into contact with the catalyst in the state that the monomer or the initiator is not sufficiently dissolved or melted, a reaction may be carried out unevenly.

The raw materials sent by the feeding pump 10 are optionally sufficiently stirred by a stirring device of the reaction unit 13, or heated to the predetermined temperature by a heater 13a when transported. As a result, the monomer is polymerized in the presence of the catalyst in the reaction unit 13. Moreover, a few filters may be provided inside the reaction unit 13. By providing the filters, the polymer product is prevented from being contaminated with the solid catalyst, when the solid catalyst is used (polymerization step).

The lower limit of the temperature for polymerizing the monomer (polymerization reaction temperature) is not particularly limited, but the lower limit thereof is 20° C. or higher, more preferably 40° C. or higher. When the polymerization reaction temperature is lower than 20° C., it may take a long time to melt the monomer with the compressive fluid depending on a type of the monomer for use, melting may be insufficient, or an activity of the solid catalyst may be low. As a result, the reaction speed may be reduced during the polymerization, and therefore it may not be able to carry out the polymerization reaction quantitatively. The upper limit of the polymerization reaction temperature is not particularly limited, but it is preferably 200° C. or lower, preferably 180° C. or lower. When the polymerization reaction temperature is 200° C. or higher, a depolymerization reaction, which is a reverse reaction of the polymerization, tends to occur equilibrately, and thus it may be difficult to carry out the polymerization reaction quantitatively. Note that, the polymerization reaction temperature is controlled by the heater 13a provided to the reaction unit 13, or heat externally applied to the reaction unit 13. When the polymerization reaction temperature is measured, moreover, a polymer obtained by the polymerization reaction may be used.

In the present embodiment, the polymerization reaction time (the average retention time in the reaction unit 13) is appropriately set depending on a target molecular weight of a polymer to be produced, but the polymerization reaction time is typically preferably within 30 hours, more preferably within 20 hours, and even more preferably within 10 hours. In accordance with the production method of the present embodiment, the polymerization reaction time can be set within 1 hour, which is a short period that has not been realized with polymerization of a monomer in a compressive fluid performed in accordance with a conventional method.

A moisture content in the reaction unit 13 is preferably 4 mol % or lower, more preferably 1 mol % or lower, and even more preferably 0.5 mol % or lower, relative to 100 mol % of the monomer. When the moisture content is greater than 4 mol %, it may be difficult to control a molecular weight of a resulting polymer, as the moisture itself acts as an initiator. In order to control the moisture content in the polymerization system, an operation for removing mixtures contained in the monomer and other raw materials may be optionally provided as a pretreatment.

The polymer product P obtained after completing the polymerization reaction in the reaction unit 13 is discharged from the reaction unit 13 by the metering pump 14. The speed for discharging the polymer product P by the metering pump 14 is preferably constant in order to operating with the constant pressure of the polymerization system filled with the compressive fluid, to thereby obtain a uniform polymer product. To this end, the feeding rate of the feeding system inside the reaction unit 13 and the feeding pump 10 are controlled to give constant back pressure of the metering pump 14. In order to maintain the back pressure of the feeding pump 10 constant, similarly, the feeding speed of the feeding system inside the contacting unit 9, the metering feeder 4, and the metering pumps (2, 6, 8) is controlled. The control system may be an ON-OFF control system, i.e., an intermittent feeding system, but it is in most cases preferably a continuous or stepwise control system where the rational speed of the pump or the like is gradually increased or decreased. Any of these controls realizes to stably provide a uniform polymer product.

### <Another Polymerization Method>

In the case where polymerization is carried out in a batch system by means of the polymerization reaction apparatus 200 illustrated in FIG. 4, the polymerization conditions (temperature conditions, pressure conditions) identical to those of the aforementioned continuous system may be used. In view of stability of the polymerization reaction, the amount of the compressive fluid added is preferably 0.001% by mass to 80% by mass under the polymerization conditions, more preferably 0.01% by mass or greater and equal to or less than the saturation stability of the compressive fluid to the polymerization monomer under the polymerization conditions, similar to the continuous system. Note that, the amount of the compressive fluid added is a ratio (% by mss) of the compressive fluid to a total amount of the raw materials, other additives, and the compressive fluid. Moreover, the polymerization conditions are temperature conditions and pressure conditions at the time of polymerization.

In the case where polymerization is performed in a continuous system using the polymerization reaction apparatus 100, moreover, polymerization may be carried out with a large amount of the compressive fluid relative to the raw materials. In this case, the ratio of the feeding speed of the raw materials to the feeding speed of the compressive fluid (the feeding speed of the raw materials/the feeding speed of the compressive, which is referred to as a feeding ratio) is appropriately selected depending on the intended purpose without any limitation. In view of stability of the polymerization reaction, the feeding ratio is preferably 1 or greater, more preferably 3 or greater, even more preferably 5 or greater, and particularly preferably 10 or greater. The upper limit of the feeding ratio is appropriately selected depending on the intended purpose without any limitation, but it is preferably 1,000 or less, more preferably 100 or less, and even more preferably 50 or less.

As the feeding ratio is 1 or greater, the reaction is carried out with a high concentration of the raw materials and the generated polymer product (e.g., solid content), when the raw materials and the compressive fluid are fed to the reaction unit 13. In this case, the solid content in the polymerization system is significantly different from a solid content of a polymerization system where polymerization is performed by dissolving a small amount of a monomer in a notably large amount of a compressive fluid in accordance with a conventional production method. The production method of the present embodiment is characterized by that a polymerization reaction is efficiently and stably carried out in a polymerization system having a high solid content. When the feeding ratio is greater than 1,000 in the present embodiment, it is afraid that an ability of the compressive fluid to dissolve the monomer may be insufficient, and an intended reaction may not be carried out uniformly.

In a conventional production method of a polymer product using supercritical carbon dioxide, a monomer is polymerized using a large amount of supercritical carbon dioxide, as the supercritical carbon dioxide has a low ability of dissolving a polymer product. In accordance with the polymerization method of the present embodiment, a monomer can be polymerized with a high concentration, which has not been realized in a conventional production method of a polymer product using a compressive fluid. In this case, the internal pressure of the reaction unit 13 becomes high in the presence of the compressive fluid, and thus the glass transition temperature (Tg) of the generated polymer product is reduced. As a result, the viscosity of the generated polymer product becomes low, and therefore the polymerization reaction is uniformly carried out with a high concentration of the polymer product.

### <Polymer Product>

The weight average molecular weight of the polymer product produced by the aforementioned polymer production method is preferably 500 or greater, more preferably 1,000 or greater. When the weight average molecular weight thereof is less than 500, heat resistance of the polymer product may be insufficient. Note that, there is no upper limit for the weight average molecular weight of the polymer product. When the weight average molecular weight thereof is greater than 1,000,000, however, it may not be cost efficient as productivity is reduced due to an increase in the viscosity. The molecular weight distribution (Mw/Mn), which is a value obtained by dividing the weight average molecular weight Mw of the polymer product with the number average molecular weight Mn of the polymer product is appropriately adjusted depending on the intended purpose without any limitation, but the molecular weight distribution is preferably 1.0 to 2.5, more preferably 1.0 to 2.0. When the molecular weight distribution (Mw/Mn) is greater than 2.5, it is highly possible that the polymerization reaction has been carried out inhomogeneously, and therefore it may be difficult to control physical properties of the polymer product. The weight average molecular weight and the molecular weight distribution (Mw/Mn) can be measured by gel permeation chromatography (GPC) under the following conditions. The measuring conditions for PTHF, and polytrimethylene oxide are described as follows:

### Device: ShodexGPCsystem-11

Columns: Shodex OHpack (two columns of SB806M+one column of SB802.5)

### Temperature: 60° C.

Solvent: a LiBr (0.02 mol/l) dimethyl acetoamide solution
Flow rate: 1.0 mL/min

A sample (1 mL) having a concentration of 0.5% by mass was injected to measure a molecular weight distribution of the sample polymer product under the aforementioned conditions. The number average molecular weight (Mn) and the weight average molecular weight (Mw) of the polymer product were calculated from the molecular weight distribution of the polymer product using the molecular weight calibration curve prepared from PTHF, polytriethylene oxide standard samples. The molecular weight distribution is a value obtained by dividing Mw with Mn.

In the production method of the present embodiment, a rate of a monomer transforming into a polymer (polymerization rate) is 30% by mass or greater, preferably 60% by mass or greater. When the polymerization rate is less than 30% by mass, durability of a resulting polymer product may be insufficient as a polymer material, or an operation for removing the polymerizable monomer may be additionally required. In the present embodiment, the polymerization rate means a ratio of an amount of the polymerizable monomer contributing the generation of a polymer to a total amount of the polymerizable monomer as a raw material. The amount of the monomer contributing the generation of a polymer can be determined by deducting an amount of the unreacted polymerizable monomer from an amount of the generated polymer.

### <<Use of Polymer>>

The polymer product obtained by the production method of the present embodiment is produced by the method that does not use an organic solvent. In the case where the polymer product of the present embodiment is produced by the method that does not use an organic solvent and a metal catalyst, moreover, the polymer product is substantially free from a metal atom and an organic solvent, and contains a less amount of the residual monomer. Therefore, the polymer product is excellent in safety and stability. Note that, the organic solvent is an organic compound that is a liquid at room temperature (25° C.), and ambient pressure, and is different from a compressive fluid. Accordingly, the particles of the present embodiment are widely used as various applications, such as commodities, pharmaceutical products, cosmetic products, and electrophotographic toner. Note that, in the present embodiment, the metal catalyst means a catalyst, which is used for polymerization and contains a metal. Moreover, the phrase “substantially free from a metal atom” means that a metal atom derived from a metal catalyst is not contained. Specifically, it can be said that a polymer product does not contain a metal atom, when the metal atom derived from the metal catalyst in the polymer product is detected by a conventional analysis method, such as ICP-atomic emission spectrometry, atomic absorption spectrophotometry, and colorimetry, and the result is lower than the detection limit (10 ppm). In the present embodiment, moreover, the term “organic solvent” is an organic matter solvent, which is used for dissolving the polymer product obtained through a polymerization reaction. Examples of the organic solvent include: a halogen solvent, such as chloroform, and methylene chloride; and tetrahydrofuran. The phrase “substantially free from an organic solvent” means that an amount of the organic solvent in the polymer product measured by the following method is below the detection limit (5 ppm).

### (Measuring Method of Residual Organic Solvent)

To 1 part by mass of the polymer product that is a subject of a measurement, 2 parts by mass of 2-propanol is added, and the resulting mixture is dispersed for 30 minutes by applying ultrasonic waves, followed by storing the resultant over 1 day or longer in a refrigerator (5° C.) to thereby extract the organic solvent in the polymer product. A supernatant liquid thus obtained is analyzed by gas chromatography (GC-14A, SHIMADZU CORPORATION) to determine quantities of the organic solvent and monomer residues in the polymer product, to thereby measure a concentration of the organic solvent. The measuring conditions for the analysis are as follows.

### Device: GC-14A (SHIMADZU CORPORATION)

### Column: CBP20-M 50-0.25

### Detector: FID

Injection amount: 1 μL to 5 μL
Carrier gas: He, 2.5 kg/cm²
Flow rate of hydrogen: 0.6 kg/cm²
Flow rate of air: 0.5 kg/cm²
Chart speed: 5 mm/min

### Sensitivity: Range 101×Atten 20

Temperature of column: 40° C.
Injection temperature: 150° C.

### EXAMPLES

The present embodiment is more specifically explained through Examples and Comparative Examples hereinafter, but Examples shall not be construed as to limit the scope of the present invention in any way.

### <Measurement of Molecular Weight of Polymer>

A molecular weight and molecular weight distribution of the obtained polymer product in each of Examples and Comparative Examples were measured by the method as described earlier.

### Example 1-1

Ring-opening polymerization of THF was performed by means of the batch polymerization reaction apparatus 200 illustrated in FIG. 5. The structure of the polymerization reaction apparatus 200 is described below.

Tank 21: Carbonic acid gas cylinder
Addition pot 25: Not used.
Reaction vessel 27: A 100 mL SUS316 pressure resistant vessel, which was charged in advance with 38 g of THF (manufacturer: Wako Pure Chemical Industries, Ltd.) that served as a ring-opening polymerizable monomer and was in the state of a liquid, 6.3 g of acetic acid anhydride (manufacturer: Wako Pure Chemical Industries, Ltd.), and 1 g of dry zeolite (manufacturer: TOSOH CORPORATION) serving as a catalyst.

The metering pump 22 was operated, and the valves (23, 26) were opened, to thereby supply the carbon dioxide stored in the tank 21 to the reaction vessel 27 without passing through the addition pot 25. The reaction vessel 27 was purged with carbon dioxide, and the temperature thereof was adjusted to 40° C. When the pressure inside the reaction vessel 27 reached 10 MPa, polymerization was initiated. Thereafter, a polymerization reaction of THF was performed for 30 minutes in the reaction vessel 27.

In this case, the internal atmosphere of the reaction vessel 27 was one phase, because an amount of the carbon dioxide added did not reach the saturation solubility thereof to the monomer. After the completion of the reaction, the valve 28, to which a filter was provided at the upstream side thereof, was released, to gradually return the temperature and pressure inside the reaction vessel 27 to room temperature and ambient pressure, to thereby obtain a generated mixture inside the reaction vessel 27. Subsequently, substantially unreacted THF and acetic acid anhydride were evaporated at 70° C. and −3 kPa, followed by at 170° C. and −0.3 kPa, for an analysis of the obtained product. Based on a comparison between the evaporation residues and initial substances, a transformation rate was determined to be 64% (relative to a mass of the initial substances).

Subsequently, a number average molecular weight, weight average molecular weight, and molecular weight distribution of the polymer product obtained in Example 1-1 were measured by the aforementioned method. The results are presented in Table 1-2.

### Examples 1-2 to 1-16, Comparative Example 1-1

Polymer products of Examples 1-2 to 1-16 and Comparative Example 1-1 were each obtained in the same manner as in Example 1-1, provided that at least one selected from the group consisting of the compressive fluid addition rate, the reaction time, the amount of the initiator, the polymerization pressure, the polymerization temperature, the type of the initiator, and the type of the catalyst was changed as depicted in Table 1-1. Note that, the pressure was controlled by changing the flow rate of the pump. Moreover, the compressive fluid addition rate could be adjusted depending on the amount of the monomer for use. In Example 13, moreover, the internal atmosphere of the reaction vessel 27 was two phases, as the amount of the carbon oxide added was beyond the saturation solubility thereof to the monomer.

Each of the obtained polymer products was subjected to the evaluations of various properties in the same manner as in Example 1-1.

The results are presented in Table 1-2.

Note that, details of the materials in the tables are as follows.

ZrO₂—SiO₂ catalyst: A commercial SiO₂ carrier (a product of FUJI SILYSIA CHEMICAL LTD.) (50 g) was immersed in 70 mL of a methanol solution, in which 11.7 g of ZrO(NO₃)₂.2H₂O, 9.1 g of tetraethyl silicate, and 5.7 g of urea were dissolved. After removing the methanol, which was a solvent, at 60° C. in vacuum, the obtained solid was heated to 120° C. over 1 hour, and then to 800° C. over 2 hours 30 minutes, under a flow of air. The temperature was maintained at 800° C. for 3 hours, followed by cooling the solid. An ion-exchange acid content in the ZrO₂/SiO₂ catalyst was 0.005 mmol/g.
Bleaching clay catalyst: An extrusion product having the average diameter of 1.5 mm was produced from a bleaching clay (manufactured by Sued-Chemie AG), and was dried at 150° C. just before use.

TABLE 1-1

| | Reaction conditions | | | | | | | | |
|---|---|---|---|---|---|---|---|---|---|
| | Compressive | | | | | | | | |
| | fluid | | | | Initiator | | | | Reac- |
| | | Addition | | | | Addition | Pres- | | tion |
| | | rate | Monomer | Catalyst | | rate | sure | Temp. | time |
| | Type | (mass %) | Type | Type | Type | (mass %) | (Mpa) | (° C.) | (min) |
| Ex. | CO₂ | 5 | THF | zeolite | acetic acid | 14.2 | 10 | 40 | 30 |
| 1-1 | | | | | anhydride | | | | |
| Ex. | CO₂ | 5 | THF | zeolite | acetic acid | 14.2 | 10 | 40 | 60 |
| 1-2 | | | | | anhydride | | | | |
| Ex. | CO₂ | 5 | THF | zeolite | acetic acid | 14.2 | 10 | 40 | 120 |
| 1.3 | | | | | anhydride | | | | |
| Ex. | CO₂ | 5 | THF | zeolite | acetic acid | 7.7 | 10 | 40 | 30 |
| 1-4 | | | | | anhydride | | | | |
| Ex. | CO₂ | 5 | THF | zeolite | acetic acid | 3.2 | 10 | 40 | 30 |
| 1-5 | | | | | anhydride | | | | |
| Ex. | CO₂ | 5 | THF | zeolite | acetic acid | 14.2 | 20 | 40 | 30 |
| 1-6 | | | | | anhydride | | | | |
| Ex. | CO₂ | 5 | THF | zeolite | acetic acid | 14.2 | 30 | 40 | 30 |
| 1-7 | | | | | anhydride | | | | |
| Ex. | CO₂ | 5 | THF | zeolite | acetic acid | 14.2 | 10 | 30 | 30 |
| 1-8 | | | | | anhydride | | | | |
| Ex. | CO₂ | 5 | THF | zeolite | acetic acid | 14.2 | 10 | 20 | 30 |
| 1-9 | | | | | anhydride | | | | |
| Ex. | CO₂ | 10 | THF | zeolite | acetic acid | 14.2 | 10 | 40 | 30 |
| 1-10 | | | | | anhydride | | | | |
| Ex. | CO₂ | 20 | THF | zeolite | acetic acid | 14.2 | 10 | 40 | 30 |
| 1-11 | | | | | anhydride | | | | |
| Ex. | CO₂ | 55 | THF | zeolite | acetic acid | 14.2 | 10 | 40 | 30 |
| 1-12 | | | | | anhydride | | | | |
| Ex. | CO₂ | 5 | THF | zeolite | water | 14.2 | 10 | 30 | 30 |
| 1-13 | | | | | | | | | |
| Ex. | CO₂ | 5 | THF | zeolite | 1,4-butane | 14.2 | 10 | 30 | 30 |
| 1-14 | | | | | diol | | | | |
| Ex. | CO₂ | 5 | THF | ZrO₂•SiO₂ | acetic acid | 14.2 | 10 | 40 | 30 |
| 1-15 | | | | | anhydride | | | | |
| Ex. | CO₂ | 5 | THF | bleaching | acetic acid | 14.2 | 10 | 40 | 30 |
| 1-16 | | | | clay | anhydride | | | | |
| Comp. | — | 0 | THF | zeolite | acetic acid | 14.2 | 10 | 40 | 30 |
| Ex. | | | | | anhydride | | | | |
| 1-1 | | | | | | | | | |

TABLE 1-2

| | Results | | | |
|---|---|---|---|---|
| | | Molecular | Monomer | |
| | | weight | transformation | |
| | Mn | distribution | rate (%) | Phase state |
| Ex. 1-1 | 990 | 2.4 | 64 | 1 phase |
| Ex. 1-2 | 1,090 | 2.1 | 67 | 1 phase |
| Ex. 1-3 | 1,150 | 1.9 | 71 | 1 phase |
| Ex. 1-4 | 1,490 | 2.2 | 63 | 1 phase |
| Ex. 1-5 | 2,980 | 1.9 | 62 | 1 phase |
| Ex. 1-6 | 1,220 | 1.7 | 73 | 1 phase |
| Ex. 1-7 | 1,280 | 1.7 | 75 | 1 phase |
| Ex. 1-8 | 950 | 2.3 | 63 | 1 phase |
| Ex. 1-9 | 930 | 2.5 | 58 | 1 phase |
| Ex. 1-10 | 1,000 | 2.2 | 65 | 1 phase |
| Ex. 1-11 | 1,040 | 2.1 | 65 | 1 phase |
| Ex. 1-12 | 970 | 2.7 | 48 | 2 phases |
| Ex. 1-13 | 38,000 | 2.5 | 35 | 1 phase |
| Ex. 1-14 | 29,000 | 2.3 | 48 | 1 phase |
| Ex. 1-15 | 1,030 | 2.2 | 66 | 1 phase |
| Ex. 1-16 | 1,010 | 2.3 | 64 | 1 phase |
| Comp. | 840 | 2.9 | 32 | — |
| Ex. 1-1 | | | | |

### Example 2-1

Ring-opening polymerization was performed by means of the continuous polymerization reaction apparatus illustrated in FIG. 3.

The tank 1 was charged with THF (manufacturer: Wako Pure Chemical Industries, Ltd.) as a ring-opening polymerizable monomer, the tank 5 was charged with acetic acid anhydride (manufacturer: Wako Pure Chemical Industries, Ltd.), and the reaction tube of the reaction unit 13 was charged with dry zeolite (manufacturer: TOSOH CORPORATION) as a catalyst. Note that, the tank 3 was not used.

After controlling the temperature of the device reaction path to 40° C., carbon dioxide was sent by the metering pump 8. After purging the system with carbon dioxide, the pressure inside the system was adjusted to 10 MPa. Thereafter, the metering pumps 2, 6 were operated to sequentially feed THF and acetic acid into the system. The time when the catalyst is introduced into the system was determined as a start of polymerization. A flow rate of each pump at the time of the start of the polymerization was set to give the addition rate as depicted in Table 2-1. Note that, the reaction time was a period during which the raw materials were passed through the reaction tube of the reaction unit 13, and the flow rate of the metering pump 2 was set to provide that the reaction time was to be 30 minutes. Subsequently, substantially unreacted THF and acetic acid anhydride were evaporated at 70° C. and −3 kPa, followed by at 170° C. and −0.3 kPa, for an analysis of the obtained product. Based on a comparison between the evaporation residues and initial substances, a transformation rate was determined to be 67% (relative to a mass of the initial substances).

Subsequently, a number average molecular weight, weight average molecular weight, and molecular weight distribution of the polymer product obtained in Example 2-1 were measured by the aforementioned method. The results are presented in Table 2-2.

### Examples 2-2 to 2-13, Comparative Example 2-1

Polymer products of Examples 2-2 to 2-13 and Comparative Example 2-1 were each obtained in the same manner as in Example 2-1, provided that at least one selected from the group consisting of the compressive fluid addition rate, the reaction time, the amount of the initiator, the polymerization pressure, the polymerization temperature, the type of the initiator, and the type of the catalyst was changed as depicted in Table 2-1. Note that, the pressure was controlled by changing the flow rate of the pump. Moreover, the compressive fluid addition rate could be adjusted depending on the amount of the monomer for use.

Each of the obtained polymer products was subjected to the evaluations of various properties in the same manner as in Example 2-1.

The results are presented in Table 2-2.

Note that, details of the materials in the tables are as follows.

ZrO₂—SiO₂ catalyst: A commercial SiO₂ carrier (a product of FUJI SILYSIA CHEMICAL LTD.) (50 g) was immersed in 70 mL of a methanol solution, in which 11.7 g of ZrO(NO₃)₂.2H₂O, 9.1 g of tetraethyl silicate, and 5.7 g of urea were dissolved. After removing the methanol, which was a solvent, at 60° C. in vacuum, the obtained solid was heated to 120° C. over 1 hour, and then to 800° C. over 2 hours 30 minutes, under a flow of air. The temperature was maintained at 800° C. for 3 hours, followed by cooling the solid. An ion-exchange acid content in the ZrO₂/SiO₂ catalyst was 0.005 mmol/g.
DME: dimethyl ether (manufacturer: Wako Pure Chemical Industries, Ltd.)
Oxacyclobutane (manufacturer: Tokyo Chemical Industry Co., Ltd.)
Butylene oxide (manufacturer: Showa Chemical Industry Co., LTD.)

TABLE 2-1

| | Reaction conditions | | | | | | | | |
|---|---|---|---|---|---|---|---|---|---|
| | Compressive | | | | | | | | |
| | fluid | | | | Initiator | | | | Reac- |
| | | Addition | | | | Addition | Pres- | | tion |
| | | rate | Monomer | Catalyst | | rate | sure | Temp. | time |
| | Type | (mass %) | Type | Type | Type | (mass %) | (Mpa) | (° C.) | (min) |
| Ex. | CO₂ | 5 | THF | zeolite | acetic acid | 14.2 | 10 | 40 | 30 |
| 2-1 | | | | | anhydride | | | | |
| Ex. | CO₂ | 5 | THF | zeolite | acetic acid | 14.2 | 20 | 40 | 30 |
| 2-2 | | | | | anhydride | | | | |
| Ex. | CO₂ | 5 | THF | zeolite | acetic acid | 3.5 | 10 | 40 | 30 |
| 1.3 | | | | | anhydride | | | | |
| Ex. | CO₂ | 5 | THF | zeolite | acetic acid | 14.2 | 10 | 30 | 30 |
| 2-4 | | | | | anhydride | | | | |
| Ex. | CO₂ | 5 | THF | zeolite | acetic acid | 14.2 | 10 | 30 | 60 |
| 2-5 | | | | | anhydride | | | | |
| Ex. | CO₂ | 5 | oxacyclo | zeolite | acetic acid | 14.2 | 10 | 40 | 30 |
| 2-6 | | | butane | | anhydride | | | | |
| Ex. | CO₂ | 5 | THF | zeolite | acetic acid | 14.2 | 10 | 140 | 30 |
| 2-7 | | | | | anhydride | | | | |
| Ex. | CO₂ | 55 | THF | zeolite | acetic acid | 14.2 | 10 | 140 | 30 |
| 2-8 | | | | | anhydride | | | | |
| Ex. | CO₂ | 80 | THF | zeolite | acetic acid | 14.2 | 10 | 30 | 30 |
| 2-9 | | | | | anhydride | | | | |
| Ex. | CO₂ | 5 | THF | zeolite | acetic acid | 14.2 | 10 | 220 | 30 |
| 2-10 | | | | | anhydride | | | | |
| Ex. | CO₂ | 5 | THF | ZrO₂•SiO₂ | acetic acid | 14.2 | 10 | 40 | 30 |
| 2-11 | | | | | anhydride | | | | |
| Ex. | CO₂ | 5 | THF | zeolite | 1,4-butane | 14.2 | 10 | 40 | 30 |
| 2-12 | | | | | diol | | | | |
| Ex. | CO₂ | 5 | Butylene | zeolite | acetic acid | 14.2 | 10 | 40 | 30 |
| 2-13 | | | oxide | | anhydride | | | | |
| Comp. | — | 0 | THF | zeolite | acetic acid | 14.2 | 10 | 40 | 30 |
| Ex. | | | | | anhydride | | | | |
| 2-1 | | | | | | | | | |

TABLE 2-2

| | Results | | |
|---|---|---|---|
| | | Molecular | Monomer |
| | | weight | transformation |
| | Mn | distribution | rate (%) |
| Ex. 2-1 | 1,020 | 1.8 | 67 |
| Ex. 2-2 | 1,220 | 1.7 | 69 |
| Ex. 2-3 | 2,880 | 1.8 | 66 |
| Ex. 2-4 | 1,180 | 2.0 | 65 |
| Ex. 2-5 | 1,220 | 1.6 | 71 |
| Ex. 2-6 | 1,060 | 2.2 | 59 |
| Ex. 2-7 | 1,080 | 2.3 | 61 |
| Ex. 2-8 | 980 | 2.4 | 58 |
| Ex. 2-9 | 1,160 | 1.8 | 51 |
| Ex. 2-10 | 890 | 2.7 | 41 |
| Ex. 2-11 | 1,060 | 2.2 | 59 |
| Ex. 2-12 | 28,800 | 2.5 | 48 |
| Ex. 2-13 | 12,480 | 2.0 | 51 |
| Comp. | 450 | 3.0 | 21 |
| Ex. 2-1 | | | |

### REFERENCE SIGNS LIST

1, 3, 5, 7 tank
4 metering feeder
2, 6, 8, 12, 14 metering pump
9 blending device
10 feeding pump
13 reaction vessel
15 extrusion cap
16 pressure control valve
21 tank
22 metering pump
25 addition pot
27 reaction vessel
28 valve
30 pipe
100 polymerization reaction apparatus
200 polymerization reaction apparatus

1. A method for producing a polymer, comprising:
contacting a polymerizable monomer and a compressive fluid to melt or dissolve the polymerizable monomer, followed by polymerizing the polymerizable monomer in the presence of an electrophile serving as an initiator.

2. The method according to claim 1, wherein the compressive fluid comprises carbon dioxide.

3. The method according to claim 1, wherein an amount of the compressive fluid is 80% by mass or less during the polymerizing.

4. The method according to claim 1, wherein an amount of the compressive fluid is an amount equal to or lower than a saturation solubility of the polymerizable monomer to the compressive fluid during the polymerizing.

5. The method according to claim 1, wherein the polymerizing is performed at temperature equal to or lower than 200° C.

6. The method according to claim 1, wherein the polymerizable monomer is polymerized in the presence of an acid catalyst, where the acid catalyst is a composite metal oxide catalyst, a metal oxide-bearing catalyst, a clay catalyst, an oxonium salt, protonic acid, Lewis acid, or any combination thereof.

7. The method according to claim 1, wherein the polymerizable monomer has a cyclic structure.

8. The method according to claim 7, wherein the monomer having a cyclic structure is a cyclic ether, and wherein the cyclic ether is polymerized through ring-opening polymerization in the presence of a carboxylic acid anhydride, a carboxylic acid, or both, to thereby produce a polyether.

9. The method according to claim 8, wherein the cyclic ether is tetrahydrofuran.

10. The method according to claim 8, wherein the cyclic ether is oxetane.

11. The method according to claim 1, wherein the electrophile is a C2-C12 carboxylic acid anhydride, 1,4-butanediol, water, or any combination thereof.
